(19) United States
(12) Patent Application Publication
(10) Pub. No.: US 2017/0194734 A1
(43) Pub. Date: Jul. 6, 2017

(54) MOBILE PHONE CHARGER

(71) Applicants: LE HOLDINGS (BEIJING) CO., LTD., Beijing (CN); Lemobile Information Technology (Beijing) Co., Ltd., Beijing (CN)

(72) Inventors: Fanbo KONG, Chaoyang District, Beijing (CN); Chenguo WANG, Chaoyang District, Beijing (CN)

(21) Appl. No.: 15/239,228

(22) Filed: Aug. 17, 2016

Related U.S. Application Data
(63) Continuation of application No. PCT/CN2016/088459, filed on Jul. 4, 2016.

(30) Foreign Application Priority Data
Dec. 31, 2015 (CN) 2015110325362

(51) Int. Cl. H01R 13/447; H01R 24/60; H01R 27/02; H02J 7/00

(52) U.S. Cl. CPC H01R 13/447; H02J 7/0042; H01R 24/60; H01R 27/02; H01R 2107/00

(57) ABSTRACT

The present invention involves a mobile phone charger, comprising a charger body, a Type-C port, and a port protection device, wherein the Type-C port is arranged on the charger body, and the port protection device is movably mounted on the charger body for covering and protecting the Type-C port.

### CROSS REFERENCE TO RELATED APPLICATIONS

The present application is a continuation of PCT application which has an application number of PCT/CN2016/088459 and was filed on Jul. 4, 2016. This application claims priority to Chinese Patent Application No. 2015110325362, entitled “A Mobile Phone Charger” submitted to the State Intellectual Property Office on Dec. 31, 2015, the whole content of which is integrated into the present application by citation.

### TECHNICAL FIELD

The present invention relates to the technical field of the electronic technology, specifically, involving a mobile phone charger.

### BACKGROUND

Development in mobile phone industry results in the unification of charger ports. Most of the current chargers adopt the USB Standard Receptacle A port. Type-C port supports insertion by either side, has small size, supports large current charging, supports data USB3.1, and supports Type-C PD function. Type-C port has become an important unified port for data and power. Apple-supported Type-C port charger has become commercially available. It is predictable that more chargers with Type-C port would soon be commercially available.

The current Type-C port uses the manner of Standard A, with the port bare to the outside. In practical application, the Type-C port is easy to be stuck with foreign matters due to its small size, which incurs poor contact during insertion, even burnout of the port during charging.

### SUMMARY

Considering the above problem, the present invention aims to provide a charger that can cover and protect the Type-C port arranged on the charger body.

The present invention provides a mobile phone charger, comprising a charger body, a Type-C port, and a port protection device, wherein the Type-C port is arranged on the charger body, and the port protection device is movably mounted on the charger body for covering and protecting the Type-C port.

Furthermore, the port protection device comprises a protection plate, one end of which is articulated to the charger body.

Furthermore, the other end of the protection plate is provided with a hand-held part.

Furthermore, a groove matching with the protection plate is arranged on the charger body for fastening the protection plate on the charger body.

Furthermore, the port protection device comprises a sliding plate that is movably mounted on the charger body for opening or closing the Type-C port.

Furthermore, a sliding slot matching with the sliding plate is arranged on the charger body for mounting the sliding plate.

Furthermore, the outer surface of the sliding plate is provided with a skid resistance part.

Furthermore, the mobile phone charger further comprises a power plug, wherein the Type-C port and the power plug are arranged oppositely on both ends of the charger body.

Furthermore, the mobile phone charger further comprises a power plug, wherein the Type-C port and the power plug are arranged to be vertical to each other on the charger body.

The mobile phone charger provided in the present invention is provided with a port protection device on the charger body, such that when the mobile phone charger is not used, the Type-C port is protected from the foreign matters such as dust, so as to avoid poor contact during insertion, even burnout during charging.

### BRIEF DESCRIPTION OF THE DRAWINGS

One or more embodiments is/are accompanied by the following figures for illustrative purposes and serve to only to provide examples. These illustrative descriptions in no way limit any embodiments. Similar elements in the figures are denoted by identical reference numbers. Unless it states the otherwise, it should be understood that the drawings are not necessarily proportional or to scale.

FIG. 1 is a schematic diagram for the structure of an embodiment of the mobile phone charger in the present invention; and

FIG. 2 is a schematic diagram for the structure of another embodiment of the mobile phone charger in the present invention.

### DETAILED DESCRIPTION

Various embodiments of the present invention are to be further elaborated in detail as follows with reference to the accompanying drawings. In the drawings, identical elements are represented by the same or similar reference signs. To be clear, the members in the drawings are not drawn to scale.

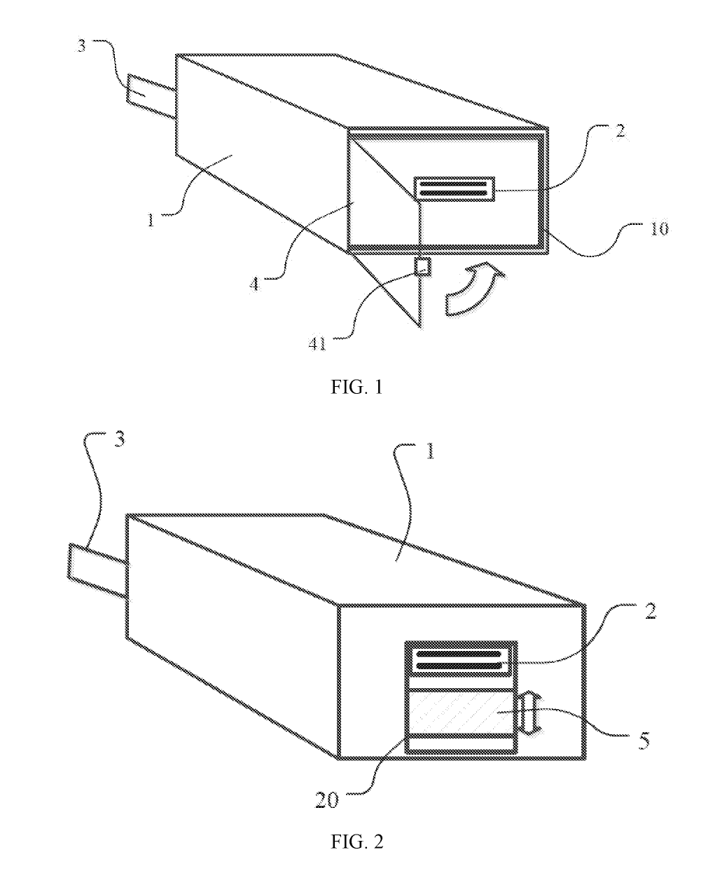

As shown in FIGS. 1-2, the mobile phone charger in the present invention comprises a charger body 1, a Type-C port 2, and a port protection device, wherein the Type-C port 2 is arranged on the charger body, and the port protection device is movably mounted on the charger body 1 for covering and protecting the Type-C port 2. The Type-C port 2 is used to be attached to the data line.

FIG. 1 provides an embodiment of the mobile phone charger. In the embodiment, the port protection device comprises a protection plate 4, one end of which is articulated to the charger body 1. The other end of the protection plate 4 is provided with a hand-held part 41 which can be a band structure fixed on the protection plate 4, such as plastic band, or a protruding structure. The protection plate 4 can be rotated relative to the Type-C port 2 via the hand-held part 41. A groove 10 matching with the protection plate 4 is arranged on the charger body 1 for fastening the protection plate 4 on the charger body 1. During charging, the protection plate 4 is opened to show the Type-C port 2, and the data line is inserted in the Type-C port 2. After charging, the protection plate 4 is closed to fasten the protection plate 4 in the groove 10 to seal and protect the Type-C port 2 from the entrance of foreign matters, such as dust.

FIG. 2 shows another embodiment of the mobile phone charger. In the embodiment, the port protection device comprises a sliding plate 5 that is movably mounted on the charger body 1 for opening or closing the Type-C port 2. A sliding slot 20 matching with the sliding plate 5 is arranged on the charger body 1 for mounting the sliding plate 5. The sliding plate 5 can move back and forth along the sliding slot 20. During charging, the sliding plate 5 slides downward to show the Type-C port 2, and the data line is inserted in the Type-C port 2. After charging, the sliding plate 5 is pushed upward to cover the Type-C port 2 to prevent foreign matters, such as dust, from entering the Type-C port 2. It functions to protect the Type-C port 2.

The outer surface of the sliding plate 5 is provided with a skid resistance part (not shown in drawings). The skid resistance part can be multiple strip protrusions vertical to the sliding direction of the sliding plate 5, or dot protrusions in array arrangement. They all belong to the design of the present invention as long as they generate a friction between the hand and the sliding plate 5 when pushing the sliding plate 5.

The mobile phone charger of the present invention also comprises a power plug 3, wherein the power plug 3 is arranged on the charger body 1. The power plug 3 is inserted in the power supply, such as inserted in a power strip. The Type-C port 2 and the power plug 3 are arranged oppositely on both ends of the charger body 1. As shown in FIG. 1-2, the Type-C port 2 and the power plug 3 can also be arranged to be vertical to each other on the charger body 1. The power plug 3 can be integrally fixed in the charger body 1, or foldingly connected to the charger body 1. Certainly, the charger body 1 can be provided with a charging port, via which a detachable patchcord is connected to the power supply, such that the mobile phone charger is used as a portable power source.

In the present application, the charger body is provided with a port protection device to protect the Type-C port from the entrance of foreign matters, such as dust, when the mobile phone charger is not in use, so as to prevent poor contact during insertion, even burnout of the port during charging.

It should be explained that in this text, relational terms such as the first, the second and the like are merely used to distinguish an entity or operation from another entity or operation, rather than requiring or suggesting any practical relationship or sequence among these entities or operations. Furthermore, the terms “comprising”, “having” or other variants aim to cover non-exclusive inclusion, such that the processes, methods, articles or devices comprising a series of factors not only comprise these factors, but also comprise other factors not listed explicitly, or further comprise factors intrinsic for such processes, methods, articles or devices. In the absence of more limitations, the factors limited by “comprising a . . . ” do not exclude that additional identical factors are also included in the processes, methods, articles or devices comprising said factors.

Lastly, it should be elaborated that obviously, the above embodiments are exemplifications merely for clearly elaborating the present invention, and are not intended for limiting the embodiments. For those skilled in the art, other variations or changes can be made based on the above elaboration, and there is no need and no way to exhaust all the embodiments. Any obvious variations or changes derived from should be covered by the protection scope of the present invention.

What is claimed is:

1. A mobile phone charger, comprising a charger body, a Type-C port, and a port protection device, wherein the Type-C port is arranged on the charger body, and the port protection device is movably mounted on the charger body for covering and protecting the Type-C port.

2. The mobile phone charger according to claim 1, wherein the port protection device comprises a protection plate, one end of which is articulated to the charger body.

3. The mobile phone charger according to claim 2, wherein the other end of the protection plate is provided with a hand-held part.

4. The mobile phone charger according to claim 2, wherein a groove matching with the protection plate is arranged on the charger body for fastening the protection plate on the charger body.

5. The mobile phone charger according to claim 1, wherein the port protection device comprises a sliding plate that is movably mounted on the charger body for opening or closing the Type-C port.

6. The mobile phone charger according to claim 5, wherein a sliding slot matching with the sliding plate is arranged on the charger body for mounting the sliding plate.

7. The mobile phone charger according to claim 5, wherein the outer surface of the sliding plate is provided with a skid resistance part.

8. The mobile phone charger according to claim 1, further comprising a power plug, wherein the Type-C port and the power plug are arranged oppositely on both ends of the charger body.

9. The mobile phone charger according to claim 1, further comprising a power plug, wherein the Type-C port and the power plug are arranged to be vertical to each other on the charger body.
